(19) United States
(12) Patent Application Publication
(10) Pub. No.: US 2012/0201023 A1
(43) Pub. Date: Aug. 9, 2012

(54) LIGHT IRRADIATING DEVICE

(75) Inventor: Kenji Yoneda, Kyoto-shi (JP)

(73) Assignee: CCS INC., Kyoto-shi, Kyoto (JP)

(21) Appl. No.: 13/500,468

(22) PCT Filed: Sep. 15, 2010
(86) PCT No.: PCT/JP2010/065920

§ 371 Date: Apr. 5, 2012

(30) Foreign Application Priority Data
Oct. 6, 2009 (JP) 2009-232777
Dec. 18, 2009 (JP) 2009-287909

(51) Int. Cl. F21V 29/00; F21V 7/00; F21V 21/00

(52) U.S. Cl. 362/218; 362/223; 362/217.05; 362/217.14

(57) ABSTRACT

In order to enable heat from luminous objects to be effectively radiated, and assembly to be simplified to facilitate downsizing and the like, a linear light irradiating device is configured such that a luminous object mounting board is contained in a bottom-equipped groove-like containing space in a body in a bending state of being elastically deformed, and also on the basis of an elastic restoring force of the board, a back surface of a luminous object mounting region in the board or vicinity of the back surface is pressed against and brought into close contact with a fore end surface of an intervening object that has thermal conductivity and is made to protrude from an inner circumferential surface of the containing space.

### TECHNICAL FIELD

The present invention relates to a light irradiating device for a linear sensor used for inspection or the like, or a linear light irradiating device used for general illumination inside or outside a room.

### BACKGROUND ART

As this sort of linear irradiation device, there has been known a device seen in Patent literature 1. This linear light irradiating device is one that is provided with: LED chips arranged in a line; and a reflector provided around them and adapted to enhance the directionality of light emitted from the LED chips by the reflector.

Meanwhile, along with a recent increase in LED power, how heat generated from an LED chip is handled has become a very important problem from the perspective of improving its life or the like. In response to this, in Patent literature 1, the LED chips are connected to heat radiation fins and a case through a heat radiation plate to dissipate the heat of the LED chips.

However, it is unexpectedly difficult to connect the heat radiation plate or the heat radiation fins to the LED chips or a printed circuit board mounted with them in a thermally sufficient state, and when only in simple contact, the heat cannot be sufficiently transferred because a gap occurs to give rise to point contact.

For this reason, conventionally, for example, contact surfaces are pressed and fixed to each other by screwing in a plurality of locations or providing a flat or coil spring. Further, in addition to this, for example, in the case of connecting a whole back surface of a printed circuit board and a case to each other, between contact surfaces, a cream-based heat transfer material such as silicone resin is sometimes thinly applied to make a surface connection without any gap. Also, recently, in some cases, adhesive tape having thermal conductivity is used to connect a printed circuit board and a heat radiation plate or the like to each other.

### CITATION LIST

### Patent Literature

Patent literature 1: JPA 2009-104998

Patent literature 2: JPA 2009-081091

### SUMMARY OF THE INVENTION

### Technical Problem

However, in such a connecting method, the screwing, adhesion, or the like is required to take time for assembly or disassembly, and in addition to this, from the structural perspective, downsizing and weight saving are also difficult Also, the contact surfaces are fixed to each other, so that, for example, if the printed circuit board is expanded by heat, an amount of the expansion cannot be accommodated, and thereby the board may be deformed and broken in a screwing location or, in the case of the adhesive tape, the tape may be peeled off to lead to a failure or the like.

The present invention is made in consideration of the problems as described above, and a desired main object thereof is to, in this sort of linear light irradiating device, enable heat from luminous objects to be effectively radiated, and assembly to be simplified to facilitate downsizing and the like.

### Solution to Problem

That is, a light irradiating device according to the present invention is provided with: a body that is formed in a tubular shape or a partial tubular shape; locking parts that are provided in two locations that are displaced in a circumferential direction on an inner circumferential surface of the body; a board that is elastically deformable and has respective lateral side parts facing to each other that is locked to the locking parts such that the board is placed in the body; a plurality of luminous objects that are mounted on a front surface of the board such that an array direction coincides with an axial direction of the body; and an intervening object having thermal conductivity, the intervening object being placed between a site intervening the locking parts in the body and a back surface of a luminous object mounting region in the board or a vicinity of the back surface, and configured to: set a separation size between the locking parts to be smaller than a size between the lateral side parts of the board to lock the board to the locking parts in a bending state where the board is elastically deformed toward an inner circumferential surface of the body; and also cause the board to press the body through the intervening object by the elastic deformation of the board.

If so, the board can be locked to the body without the use of any screws or springs, and therefore downsizing, weight saving, cost reduction, and the like based on a simplification of assembly and a reduction in the number of components can be facilitated.

Also, on the basis of the elastic force of the board itself, the luminous object mounting region or vicinity of it in the board in particular and the body can be surely thermally connected to each other through the intervening object, and therefore heat generated in the luminous objects can be extremely efficiently released to the body through the intervening object. In addition, if the body is provided with, for example, a heat radiation member, the heat can be effectively radiated.

Further, the bendable board is generally formed of a thin member, and therefore a thickness of the board hardly blocks the heat transfer.

Also, the board is not completely fixed to the body, but only pressed against the body, so that even if the board is slightly deformed by heat, the deformation is accommodated by the elasticity of the board, and therefore problems such as breakage due to thermal deformation and defective connection due to heat hardly occur.

In addition, the board is bent in an attachment state, so that the front surface of the board plays a role as a concave reflecting surface, and without particularly providing a dedicated reflecting member, directionality of light from the luminous objects is improved to obtain an effect of reducing loss light.

In order to enable a structure to be simplified and downsized, and the board to be easily attached to the body even if the body is a long-sized one, the present invention is preferably configured such that the locking parts are ones formed in a protruded rim or groove-like shape extending parallel to an extending direction, and while sliding side edge portions of the board parallel to the extending direction, the board can be locked to the locking parts.

It is reasonable from the configurational perspective that the present invention is configured such that the intervening object is one that is made to protrude inward from the inner circumferential surface of the body, and on the basis of the elastic deformation of the board, the back surface of the luminous object mounting region in the board or the vicinity of the back surface is pressed against and brought into close contact with a protruding end surface of the intervening object.

In order to simplify assembly, preferably, the intervening object can be slid in the axial direction and engaged with and attached to the body.

In particular, if the body is provided with: a body main unit provided with a through-groove that extends in the axial direction; and a heat radiation fins that is slid, and engaged with and attached to the through-groove, and the intervening object is integrally provided inside the heat radiation member, the number of components can be reduced and the components can be standardized.

In order to provide the heat radiation member with a water prevention function, preferably, the heat radiation member is broadened outward from the through-groove with respect to a circumferential direction.

Specific aspects includes one in which the body main unit is made of resin.

The present invention may be configured such that the intervening object is made to protrude from the back surface of the luminous object mounting region in the board or the vicinity of the back surface, and on the basis of the elastic deformation of the board, a protruding end surface of the intervening object is pressed against and brought into close contact with the body.

Also, if on a plane surface facing to the luminous objects in the body, a translucent portion for transmitting light is provided, by setting a height of the intervening object to be low, the luminous objects can be positioned in locations that are on the deep inner circumferential surface of the containing space and distant from the translucent portion. Accordingly, if the translucent portion is made to be provided with light diffusivity, even if the luminous objects are discretely arranged, a distance from the luminous objects to the translucent portion is as long as possible, and therefore a degree of light unevenness in the translucent portion is reduced.

In order to improve the light directionality and reduce the loss light, preferably, the surface on a luminous object mounting side of the board is formed as a minor surface or a highly reflective white surface.

### ADVANTAGEOUS EFFECTS OF INVENTION

According to the light irradiating device according to the present invention configured as described, the board can be locked to the body without the use of any screws or springs, and therefore downsizing, weight saving, cost reduction, and the like based on simplification of assembly and reduction in number of components can be facilitated.

Also, on the basis of the elastic force of the board itself, the luminous object mounting region or vicinity of it in the board in particular and the body can be surely thermally connected to each other through the intervening object, and therefore heat generated in the luminous objects can be extremely efficiently released to the body through the intervening object.

Further, the board is bent in the attachment state, so that the front surface of the board plays a role as the concave reflecting surface, and without particularly providing a dedicated reflecting member, the directionality of light from the luminous objects is improved to obtain an effect of reducing loss light.

### BRIEF DESCRIPTION OF DRAWINGS

FIG. 1 is an overall perspective view of a light irradiating device in one embodiment of the present invention.

FIG. 2 is a cutaway perspective view illustrating an internal structure of the light irradiating device in the same embodiment.

FIG. 3 is an end view illustrating a side circumferential plate member and the like of the light irradiating device in the same embodiment.

FIG. 4 is an exploded perspective view illustrating a board and body in the same embodiment.

FIG. 5 is a partially enlarged cross-sectional view that enlarges and illustrates the vicinity of a chip LED of a light irradiating device in another embodiment of the present invention.

FIG. 6 is a partially enlarged cross-sectional view that enlarges and illustrates the vicinity of a chip LED of a light irradiating device in still another embodiment of the present invention.

FIG. 7 is a cross-sectional view of a light irradiating device in yet another embodiment of the present invention.

FIG. 8 is a partially enlarged cross-sectional view that enlarges and illustrates the vicinity of a chip LED of a light irradiating device in still yet another embodiment of the present invention.

FIG. 9 is a cross-sectional view of a light irradiating device in a further embodiment of the present invention.

FIG. 10 is an exploded perspective view illustrating a board and a body of a light irradiating device in a still further embodiment of the present invention.

FIG. 11 is a cross-sectional view of a light irradiating device in a yet further embodiment of the present invention.

FIG. 12 is a cross-sectional view of a light irradiating device in a still yet further embodiment of the present invention.

FIG. 13 is a cross-sectional view and partial plan view of a light irradiating device in an alternate embodiment of the present invention.

FIG. 14 is a partial cross-sectional view of a light irradiating device in a still alternate embodiment of the present invention.

FIG. 15 is a partial cross-sectional view of a light irradiating device in a yet alternate embodiment of the present invention.

FIG. 16 is a front view of a light irradiating device in a still yet alternate embodiment of the present invention.

FIG. 17 is a back view of the light irradiating device in the same embodiment.

FIG. 18 is a side view of the light irradiating device in the same embodiment.

FIG. 19 is an overall perspective view of the light irradiating device in the same embodiment.

FIG. 20 is a partial perspective view of the light irradiating device in the same embodiment.

FIG. 21 is a cross-sectional view illustrating an internal structure of the light irradiating device in the same embodiment.

FIG. 22 is a partial perspective view of a light irradiating device in a different embodiment of the present invention.

FIG. 23 is a cross-sectional view illustrating an internal structure of the light irradiating device in the same embodiment.

FIG. 24 is a partial perspective view of a light irradiating device in a still different embodiment of the present invention.

FIG. 25 is a cross-sectional view illustrating an internal structure of the light irradiating device in the same embodiment.

### DESCRIPTION OF THE EMBODIMENTS

In the following, one embodiment of the present invention is described with reference to the drawings.

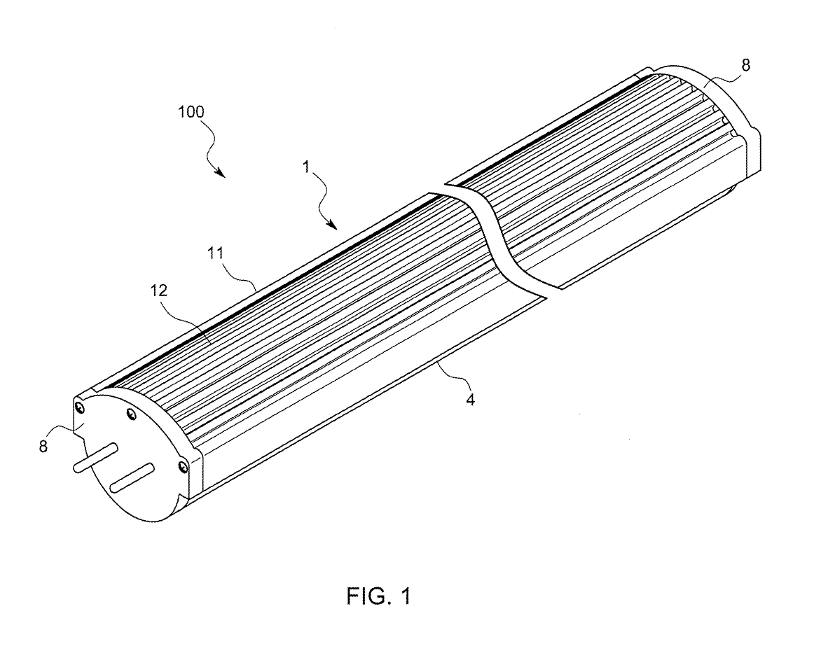

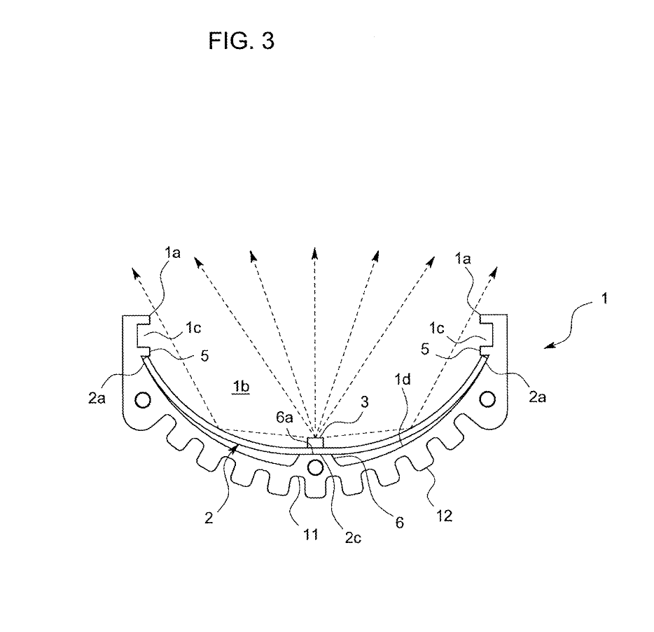

A light irradiation device 100 according to the present embodiment is a linear one that can be used for general illumination, illumination for inspection, illumination for growing plants, or the like, inside or outside a room, and, as illustrated in FIGS. 1 to 4, is provided with: a long-sized body 1 substantially having a shape obtained by vertically cutting a cylindrical body along its extending direction (synonymous with an axial direction, and hereinafter sometimes referred to as the axial direction); base members 8 that are respectively attached to both end parts of the body 1; a board 2 that is contained and arranged inside the body 1; chip type LEDs 3 that are mounted on the board 2 and serve as luminous objects; and a cover 4 that is attached on an opening 1a of the body 1 and serves as a translucent member.

The respective parts are described in detail.

The body 1 is formed in a partial cylindrical shape, and includes: a body main unit 11 made of, for example, metal, inside which a linear bottom-equipped groove-like containing space 1b is formed; and a heat radiation member 12 that is integrally formed on an outer surface of the body main unit 11 and formed in a protruded rim shape (fin shape). Note that the “partial cylindrical shape” refers to a shape that is a partially missing annular shape when a cylinder is viewed from an end surface.

The board 2 is one that is referred to as a so-called printed circuit board on which wiring is preliminarily printed, and the present embodiment uses a printed circuit board of a type that is as thin as 0.5 mm or less and bent by being elastically deformed. Also, in a natural state in which external force is not applied, the board 2 has a long-sized rectangular flat plate shape, of which a longer direction size is slightly smaller than a longer direction size of the containing space 1b of the cylindrical body and a width direction size is larger than a width direction size of the containing space 1b. Further, almost a whole of at least an LED mounting side surface of the board 2 is formed as a minor surface by being applied with reflective coating, or the like, and has thereby improved reflectance. In addition to the mirror surface, the surface may be formed as a white surface by being applied with white paint, or the like.

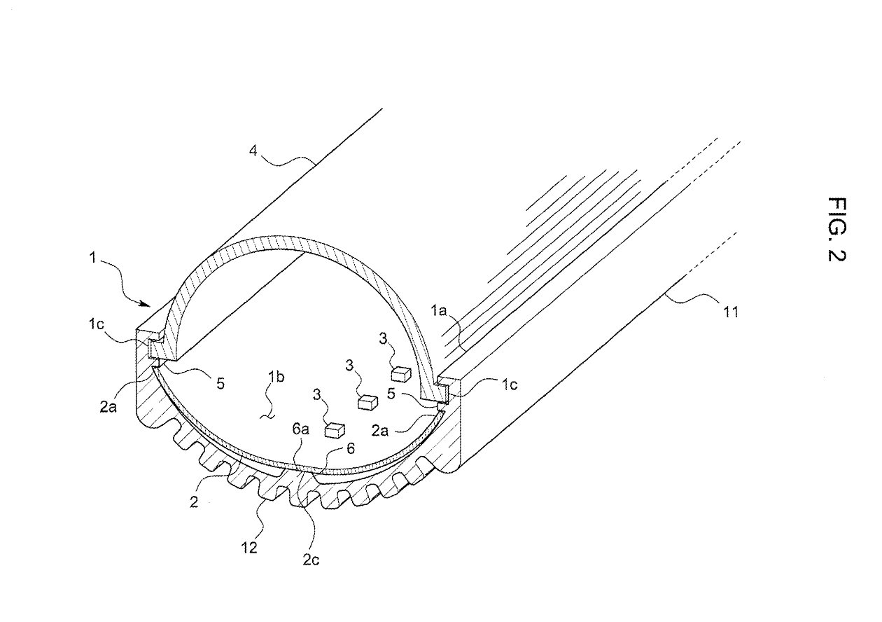

Each of the chip type LEDs 3 is one of a surface-mount high luminance type that emits, for example, white light, and in the present embodiment, is configured to utilize an LED element (not illustrated) that emits near ultraviolet light and a phosphor member that wavelength-converts the light emitted from the LED element to the white light. Also, as illustrated in FIGS. 2 to 4, the chip type LEDs 3 are mounted at regular intervals in the width direction center on the front surface of the board 2 in line from one end to the other end along the longer direction.

The cover 4 has light diffusivity; is formed in a semi-cylindrical shape having almost the same length as that of the body 1; and is attached to the body 1 so as to cover the opening la of the containing space 1b. In the present embodiment, attachment grooves 1c are respectively formed in side edge portions that are parallel to the longer direction in the body main unit 11, and the cover 4 is adapted to be attached to the body main unit 11 by sliding and inserting side edge portions of the cover 4 into the attachment grooves 1c, respectively.

Thus, the present embodiment is adapted such that, in edge portions parallel to the extending direction of the body main unit 11, i.e., in edge portions of the opening 1a, locking parts 5 are respectively provided to lock respective lateral side parts 2a parallel to the extending direction of the board 2 to the locking parts 5. The locking parts 5 are respectively formed in protruded rim shapes that extend from the edge portions of the body main unit 11 toward directions facing to each other, and between the locking parts 5 and an inner circumferential surface of the body main unit 11, the lateral side parts 2a of the board 2 are locked.

Also, from a width direction center on the inner circumferential surface 1d of the body main unit 11, an intervening object 6 having a protruded rim shape that extends from the one end to the other end along the longer direction is made to protrude on the whole. A protruding end surface 6a (hereinafter also referred to as a fore end surface 6a) of the intervening object 6 is parallel to an opening plane of the body 1, and a width thereof is set to be the same as or larger than a width of the chip type LEDs 3.

Meanwhile, as described above, a width size of the opening 1a, i.e., a size between the locking parts 5 is set to be smaller than the width direction size of the board 2. Accordingly, in a state where the board 2 is locked to the locking parts 5, the board 2 is bent toward the containing space 1b side; however, at this time, a back surface of an LED mounting region in the board 2 and a front surface of the intervening object 6 are configured to be pressed against and brought into contact with each other by elastic restoring force of the board 2 that attempts to be restored from a bending state to a flat plate state. In this manner, the board 2 is, in a cross-sectional view, supported by and fixed to only three locations, i.e., the both lateral side parts 2a and central part (back surface 2c of the LED mounting region) thereof.

As an example of a method for locking the board 2, it is only necessary to, while bending the board 2, slide and insert the board 2 into the containing space 1b from an end surface of the body main unit 11 along the longer direction (extending direction). After that, the base members 8 are attached to the body main unit 11 to non-slidably fix the board 2.

Thus, according to the configuration of the present embodiment, the elastic force of the board 2 surely presses the back surface 2c of the LED mounting region against the intervening object 6 to bring the back surface 2c into surface contact with the intervening object 6, and therefore heat generated in the chip type LEDs 3 can be efficiently released to the body 1 through the intervening object 6. Also, the bendable board 2 is generally formed of a thin member, so that a blocking influence on heat transfer due to its thickness can be reduced and from such a perspective as well, the heat transfer to the intervening object 6 can be efficiently made.

In addition, when the board 2 is brought into contact with the intervening object 6, screwing, a special tool, or the like is not required, but the board 2 is simply slid, and therefore assembly is dramatically simplified.

Also, the board 2 is bent and the front surface thereof plays a role as a concave reflecting surface, and therefore without particularly providing a dedicated reflecting member, effects of being able to improve directionality of the light from the chip type LEDs 3 and reduce loss light are also obtained.

Further, the present embodiment is configured to reduce a height of the intervening object 6 (a distance from the inner circumferential surface 1d of the body 1 to the fore end surface 6a) and thereby arrange the chip type LEDs 3 near the inner circumferential surface 1d of the body 1 to keep them away from the opening 1a and the cover 4 as much as possible, and therefore an effect is also produced in which, when viewing the cover 4 in a lighting state, a degree of light unevenness appears to be smaller and a whole of the cover 4 appears to uniformly light.

Next, other embodiments of the present invention are described. Note that in the following variations, members corresponding to those in the above-described embodiment are added with the same symbols.

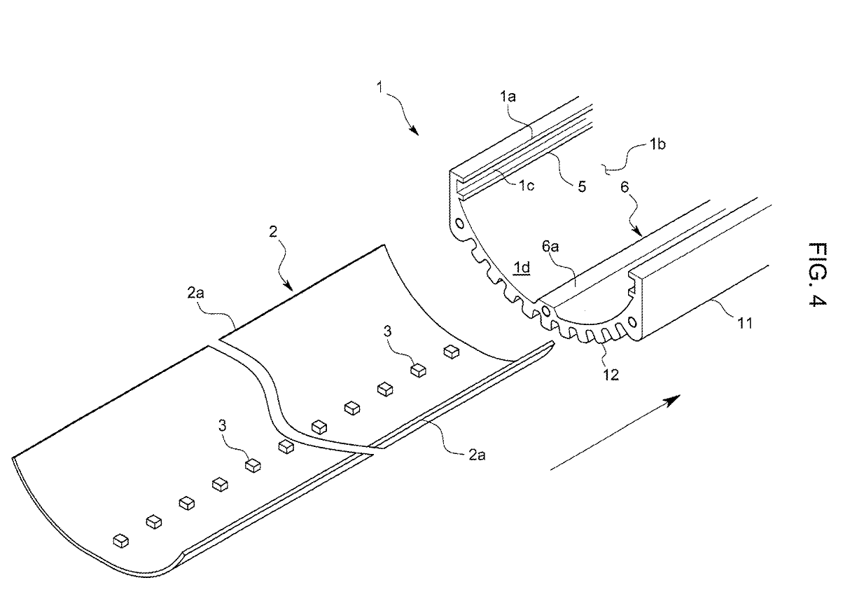

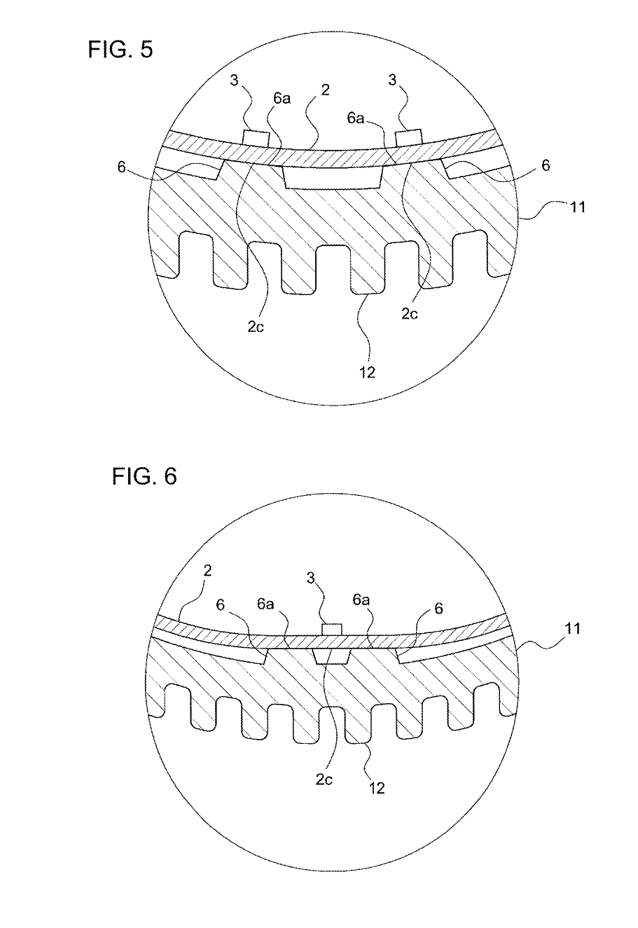

For example, as illustrated in FIG. 5, the chip type LEDs 3 may be arranged in a plurality of lines. In such a case, preferably, a plurality of intervening objects 6 are also provided in accordance with the LED lines.

Also, as illustrated in FIG. 6, intervening objects 6 are not necessarily brought into contact with the region corresponding to the back surface of the chip type LEDs 3, but depending on a required amount of heat radiation, may be brought into contact with, for example, the vicinity of the back surface of the chip type LED mounting region in the board 2.

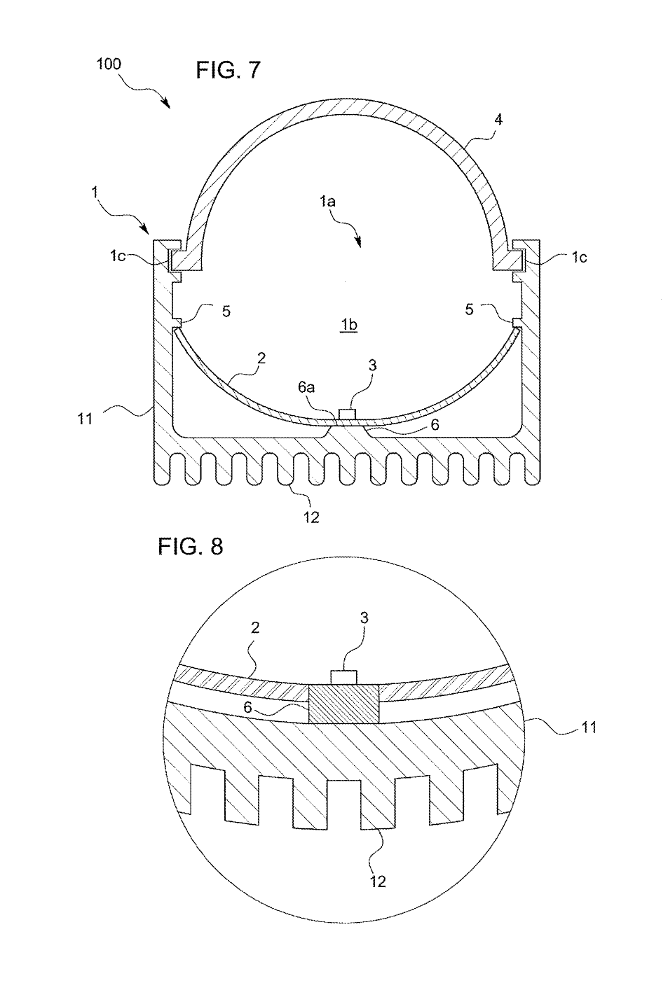

In addition, the shape of the body 1 is not limited to the partial cylindrical shape, but as illustrated in FIG. 7, may be a rectangular tubular shape of which a part is opened. Also, the locking parts 5 are not necessarily provided near the opening 1a, but, as illustrated in the same diagram, may be set in locations that are deep distant from the opening 1a of the containing space 1b. The translucent member is not necessarily required, and only the opening may be simply provided.

Further, as illustrated in FIG. 8, the intervening object 6 may be provided on the board 2 side, or may be adapted to protrude from both of the board and the body inner circumferential surface. Also, as illustrated in FIG. 9, the cover 4 may be one having a flat plate shape.

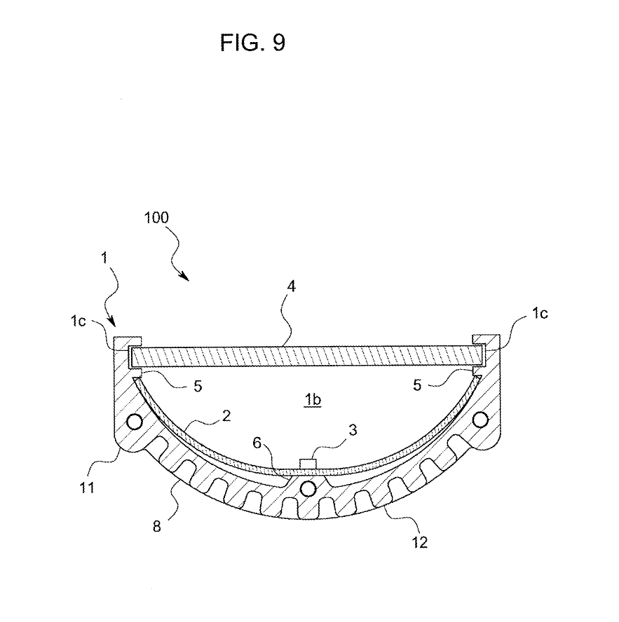

As illustrated in FIG. 10, a plurality of boards 2 may be contained in one body 1 in series.

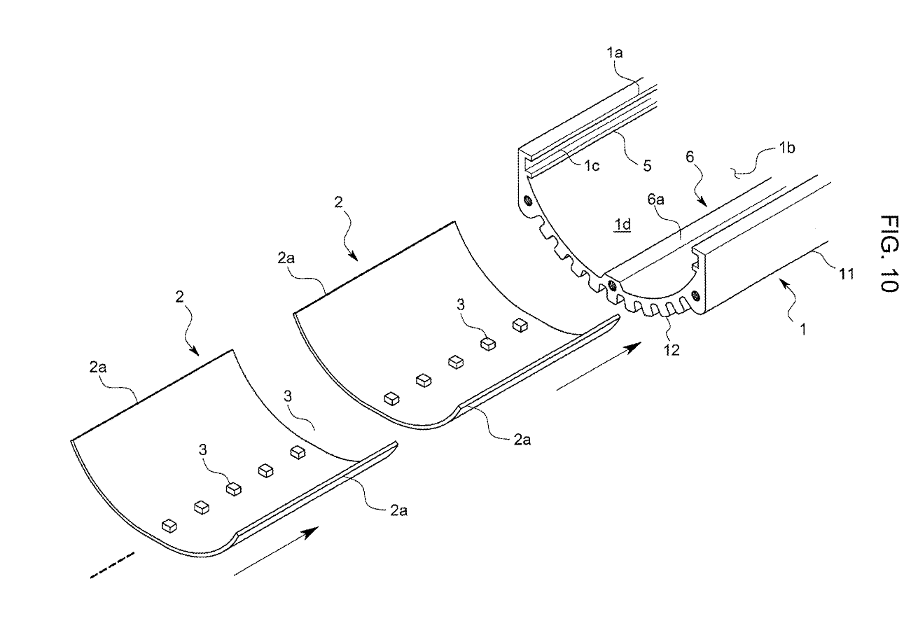

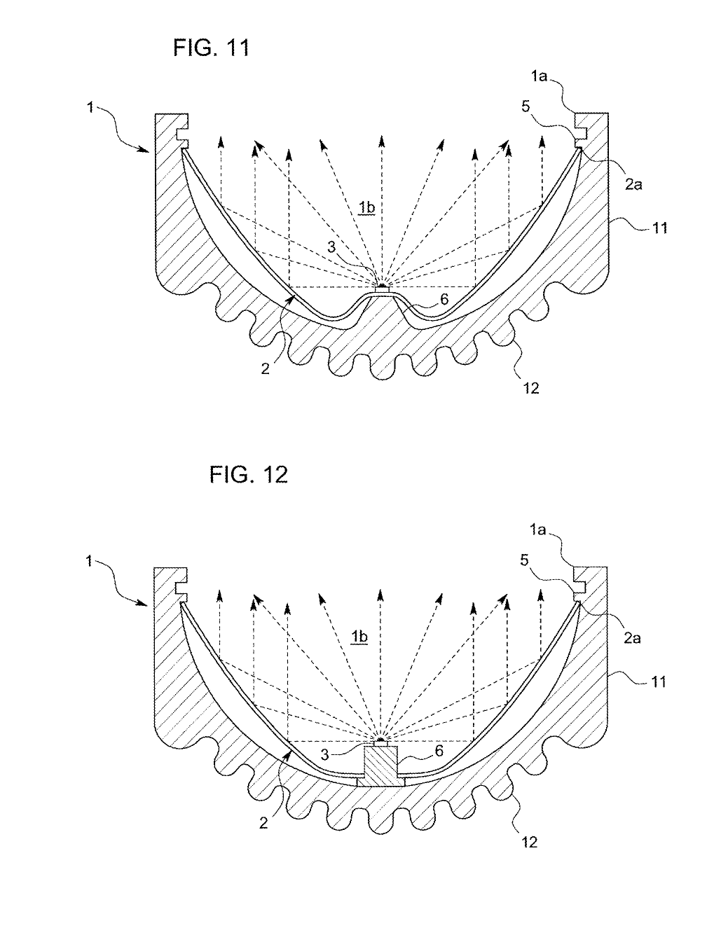

Also, in the above-described embodiment, an amount of deflection of the board 2 is, in the state where the board 2 is attached to the body 1, set so as to just deform the board 2 into the substantially partial circular shape in the cross-sectional view; however, as illustrated in FIG. 11, the present invention may be adapted such that the amount of deflection of the board 2 is increased, and in a transverse cross-sectional view, the board 2 is raised to some extent in the center by the intervening object 6 and formed in a substantially W-shape in the transverse cross-sectional view. In this case, if a side part of the board 2 except for the central part is formed to have a parabolic shape and the LEDs 3 are positioned at a focus of the parabola, reflected light on the board front surface becomes parallel light traveling toward the opening to improve the light directionality. The board may be one that is, as in the above-described embodiment, of a flat plate shape in the natural state of being placed on a plane surface, or may be preliminarily bent, which is in a state close to the state of being arranged in the containing space.

From the perspective of positioning the LEDs 2 at the focus of the parabola, as illustrated in FIG. 12, the intervening object 6 may be made to penetrate through the board 2 and protrude from the front surface of the board 2.

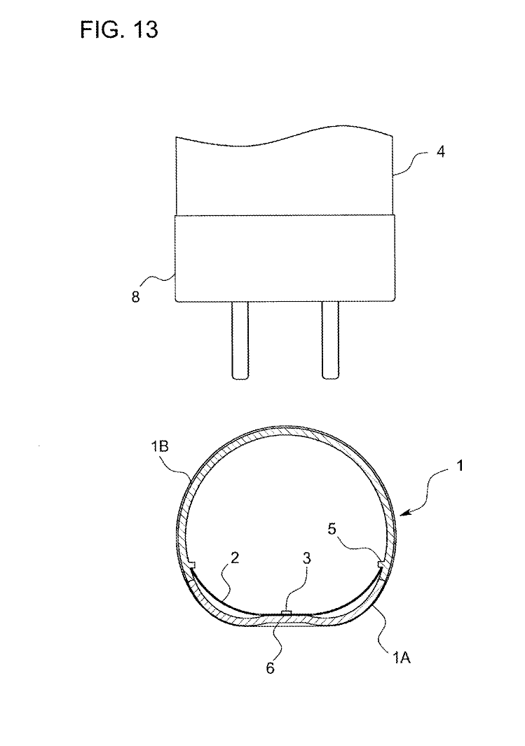

Further, as illustrated in FIG. 13, the body 1 is not formed in the partial cylindrical shape, but may be formed in a cylindrical shape. In this case, a whole of the body may be formed of glass or resin to have translucency, or for example, if the body 1 is integrally molded such that a board side 1A of the body 1 has non-translucency and a side opposite to the board (hereinafter referred to as an “opposite-to-board side”) 1B has translucency, simplification of manufacturing can be facilitated. At this time, it is preferable from the perspective of molding to use the same resin and different mixing materials for the substrate side 1A and the opposite-to-board side 1B of the body 1. In this case, it is possible to consider a configuration in which, for example, for the board side body 1A, polycarbonate resin mixed with thermally conductive filler is used to enhance heat radiation performance, and for the opposite-to-board side body 1B, polycarbonate resin mixed with light diffusing filler is used. Of course, the translucent member may be clear and transparent.

Thus, if such a simple molding method is employed, the body 1 is formed in a perfect cylindrical shape, and therefore the board 2 must be slid and inserted in the axial direction; however, even by such sliding insertion, according to the present invention, a special effect of being able to ensure reliable thermal conduction by the elastic deformation of the board 2 can be obtained.

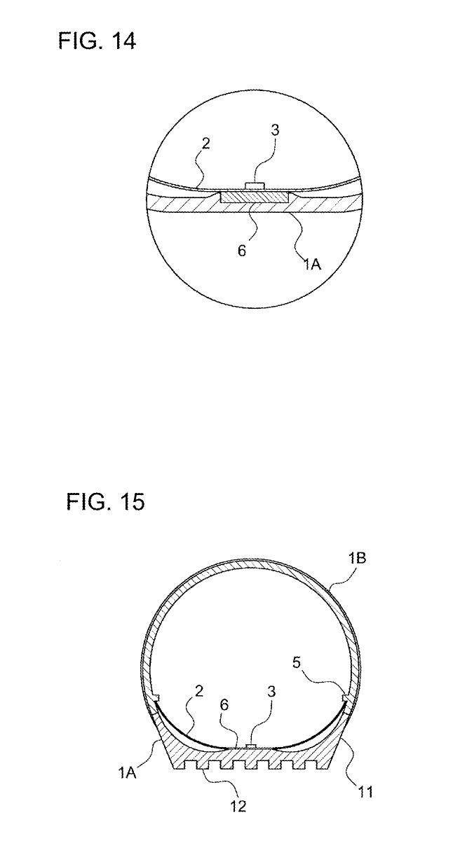

Also, as illustrated in FIG. 14, the intervening object 6 may be slid and inserted as a metal plate that is a physically separate body from the body 1. Further, an aspect as illustrated in FIG. 15 is also possible.

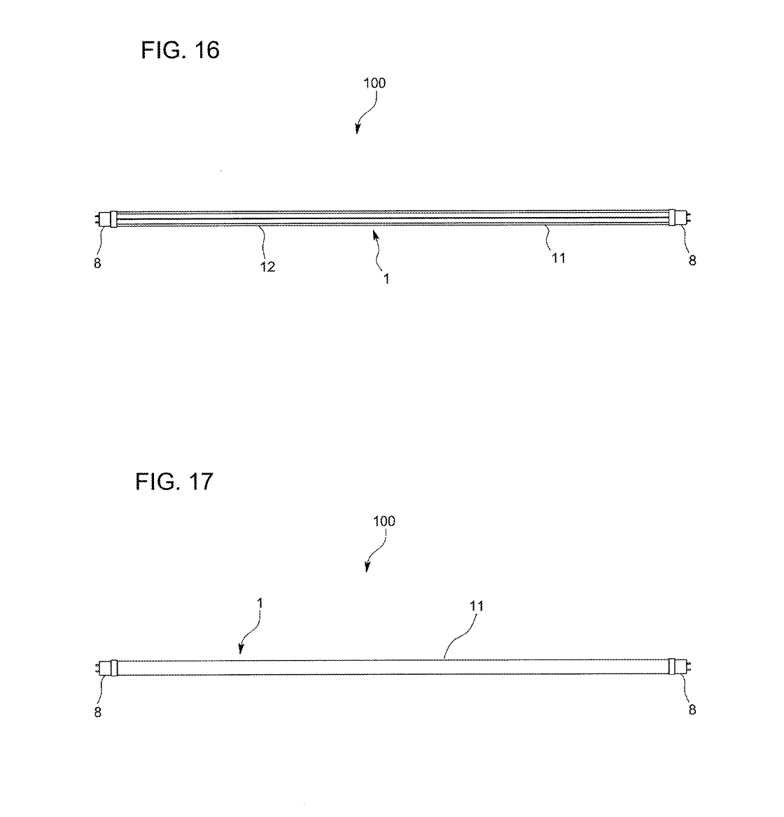

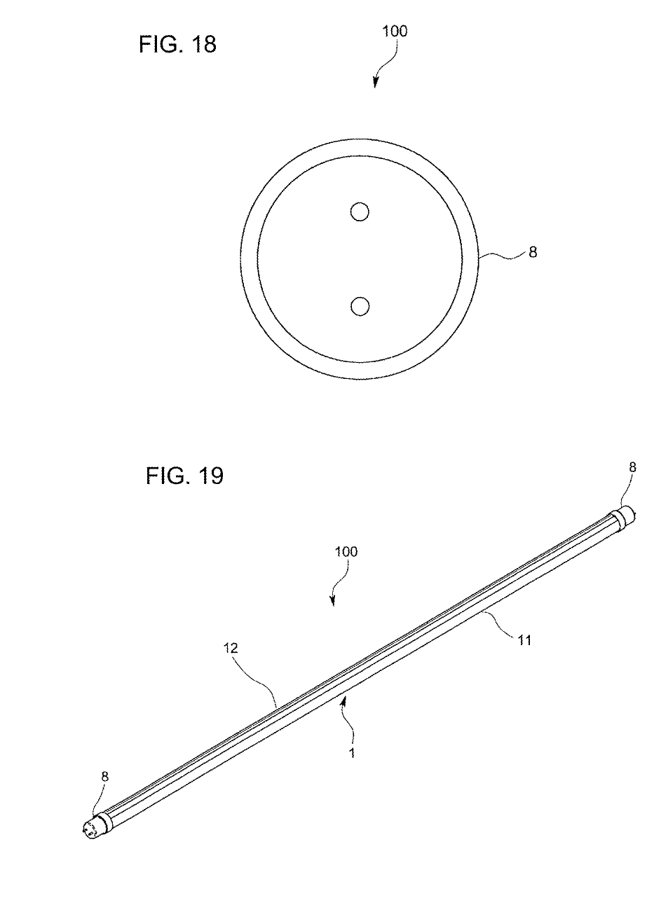

A still yet alternate embodiment of the present invention is described referring to FIGS. 16 to 21.

A light irradiating device 100 according to the present embodiment is characterized by, in particular, a body 1, and therefore the description is provided with a focus on the body 1.

The body 1 is, as illustrated in FIGS. 16 to 19, one provided with: a body main unit 11 that is formed in a tubular (cylindrical) shape; and a heat radiation member 12 that is attached to the body main unit 11 as a separate body.

The body main unit 11 is made of resin having translucency as a whole, and, as in the above-described embodiment, locking parts 5 that extend in an axial direction are provided in two locations that are mutually displaced in a circumferential direction of an inner circumferential surface. An elastic printed circuit board 2 mounted with LEDs 3 is adapted to be slid, and locked and attached to the locking parts 5.

In a just intermediate position between the two locking parts 5 in the body 1, i.e., in a position facing to a back surface of a luminous objects mounting region in the board 2, a through-groove 11a that extends in the axial direction is formed, and an intervening object 6 is slid in the axial direction, and engaged with and attached to the through-groove 11a.

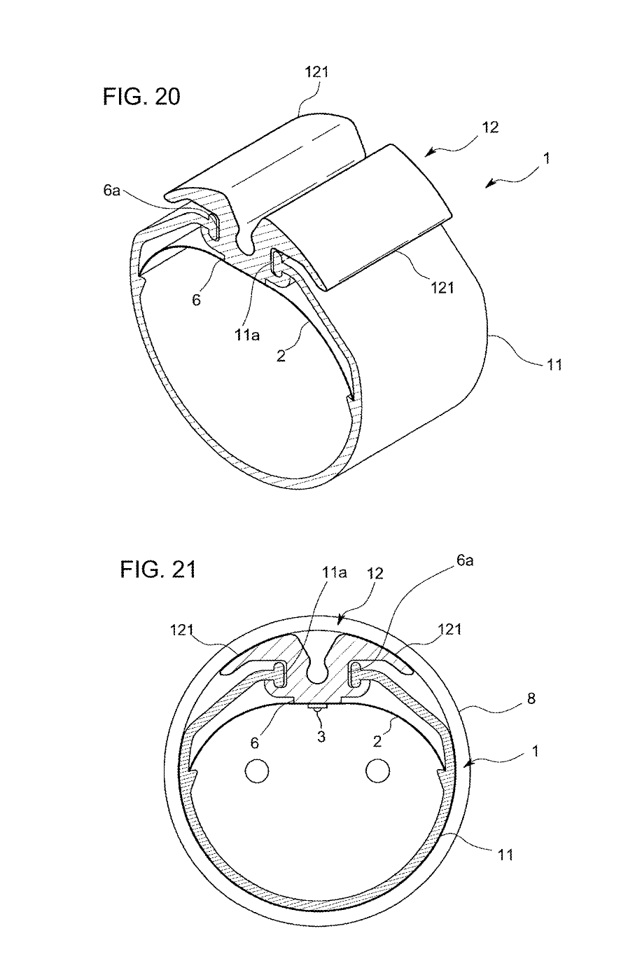

The intervening object 6 is, as illustrated in FIGS. 20 and 21, a metallic one formed in a long-sized shape, and on side surfaces thereof, bottom-equipped grooves 6a that engage with side edge portions of the through-groove 11a are provided, respectively.

Also, on a radial direction outside of the intervening object 6, a heat radiation member 12 is integrally formed. The heat radiation member 12 is, as viewed from an end surface direction, provided with a flange part 121 that extends outward from the through-groove 11a. The flange part 121 is, when the light irradiating device 100 is arranged in terms of posture such that the heat radiation member 12 is on an upper side, formed in a shape that hangs down toward outside, and plays a role as not only heat radiation but also a water prevention umbrella that prevents water droplets and the like from above from intruding into the body. This is effective when the present light irradiation device is used for, for example, a hydroponics apparatus, an aquarium illumination device, or the like.

Assembly of the light irradiating device 100 having such a configuration is described.

First, the board 2 mounted with the LEDs 2 is attached to the body main unit 11 by sliding the board 2 in the axial direction while bending the board 2. Then, an integral molding of the intervening object 6 and the heat radiation member 12 is slid in the axial direction with being pressed against the board 2 and engaged with the body through-groove 11a.

Thus, according to such a configuration, the sliding engagement of the board 2 can be very smoothly performed as compared with that in the above-described embodiment. This is because when the board 2 is slid in the axial direction and engaged, if the intervening object 6 is in a state of having been already attached to the body, in the course of the sliding, the board 2 may be bent or prevented from being pushed in any more due to the bending because friction is large and the board 2 is relatively thin and has small rigidity; however, as in the present embodiment, the elastic printed circuit board is attached to the body 1 without the intervening object 6, so that friction at the time of the sliding is small, and therefore the assembly can be smoothly performed.

On the other hand, the intervening object 6 and the heat radiation member 12 are metallic rod-like ones having sufficient rigidity, and therefore at the time of the sliding engagement, even if there is friction with the board 2, any trouble does not particularly occur.

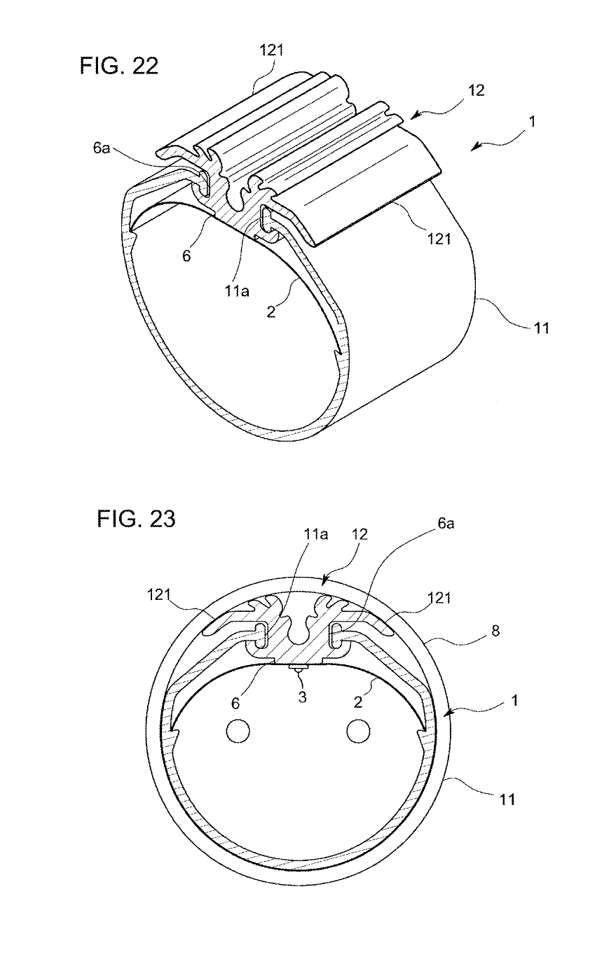

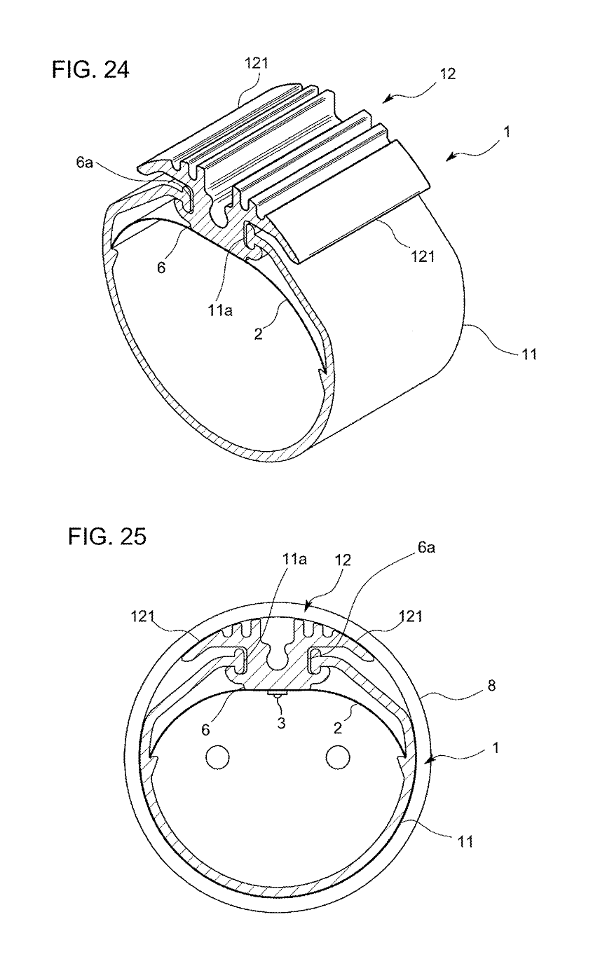

Further, the body 1 is separated into the body main unit 11 made of resin and the metallic heat radiation member 12, so that in the case where heat radiation performance should be varied depending on a difference in light amount of the LEDs 3, it is only necessary to arrange a lineup of only heat radiation members 12 without changing the body main unit 11, and therefore components can be standardized. As the heat radiation member 12, ones having various shapes as illustrated in FIGS. 22 to 25 are possible. Note that, in FIGS. 22 to 25, the other components such as the body 1 and base members 8 are the same as those in FIGS. 16 to 19, and therefore description thereof is omitted.

Besides, the present invention can be variously modified without departing from the scope thereof.

### INDUSTRIAL APPLICABILITY

The light irradiating device according to the present invention is configured such that the board can be locked to the body without the use of any screws or springs, and therefore downsizing, weight saving, cost reduction, and the like based on simplification of assembly and reduction in number of components can be facilitated. Also, on the basis of the elastic force of the board itself, the luminous object mounting region or vicinity of it in the board in particular and the body can be surely thermally connected to each other through the intervening object, and therefore heat generated in the luminous objects can be extremely efficiently released to the body through the intervening object. Further, the board is bent in the attachment state, so that the front surface of the board plays a role as the concave reflecting surface, and without particularly providing a dedicated reflecting member, the directionality of light from the luminous objects is improved to obtain an effect of reducing loss light.

### REFERENCE CHARACTERS LIST

100: Light irradiating device

1: Body

1a: Opening

1b: Containing space

1d: Inner circumferential surface

12: Heat radiation member

2: Board

2a: Board lateral side part

2c: Back surface of luminous object mounting region

3: Luminous object (chip type LED)

4: Translucent member (cover)

5: Locking part

6: Intervening object

1. A light irradiating device comprising:
a body that is formed in a tubular shape or a partial tubular shape;
locking parts that are provided in two locations that are displaced in a circumferential direction on an inner circumferential surface of the body;
a board that is elastically deformable, and has respective lateral side parts facing each other, that is locked to the locking parts such that the board is placed in the body;
a plurality of luminous objects that are mounted on a front surface of the board such that an array direction coincides with an axial direction of the body; and
an intervening object having thermal conductivity, the intervening object being placed between a site intervening the locking parts in the body and a back surface of a luminous objects mounting region in the board or a vicinity of the back surface, the light irradiating device being configured to:
set a separation size between the locking parts to be smaller than a size between the lateral side parts of the board to lock the board to the locking parts in a bending state where the board is elastically deformed toward an inner circumferential surface of the body; and
cause the board to press the body through the intervening object by the elastic deformation of the board.

2. The light irradiating device according to claim 1, configured to slide the lateral side parts of the board in the axial direction to be able to lock the lateral side parts to the locking parts.

3. The light irradiating device according to claim 1, configured such that
the intervening object is one that is made to protrude inward from the inner circumferential surface of the body, and
on a basis of the elastic deformation of the board, the back surface of the luminous object mounting region in the board or the vicinity of the back surface is pressed against and brought into close contact with a protruding end surface of the intervening object.

4. The light irradiating device according to claim 3, wherein
the intervening object can be slid in the axial direction and engaged with and attached to the body.

5. The light irradiating device according to claim 3, wherein
the body is provided with: a body main unit comprising a through-groove that extends in the axial direction; and a heat radiation member that is slid, and engaged with and attached to the through-groove, and
the intervening object is integrally provided inside the heat radiation member.

6. The light irradiating device according to claim 5, wherein
the heat radiation member is broadened outward from the through-groove with respect to a circumferential direction.

7. The light irradiating device according to claim 5, wherein
the body main unit is made of resin.

8. The light irradiating device according to claim 1, configured such that
the intervening object is made to protrude from the back surface of the luminous object mounting region in the board or the vicinity of the back surface, and
on a basis of the elastic deformation of the board, a protruding end surface of the intervening object is pressed against and brought into close contact with the body.

9. The light irradiating member according to claim 1, wherein
on a plane surface facing to the luminous objects in the body, a translucent portion for transmitting light is provided.

10. The light irradiating device according to claim 1, wherein
the front surface of the board is formed as a mirror surface or a highly reflective white surface.
